(19) United States
(12) Patent Application Publication
(10) Pub. No.: US 2007/0058603 A1
(43) Pub. Date: Mar. 15, 2007

(54) Apparatus and method for estimating and reporting a carrier to interference noise ratio in a multi-antenna system

(75) Inventors: Seong-Wook Song, Gwacheon-si (KR); Young-Mo Gu, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/502,443

(22) Filed: Aug. 11, 2006

(30) Foreign Application Priority Data
Aug. 12, 2005 (KR) 2005-74522

(51) Int. Cl. H04B 7/216

(52) U.S. Cl. 370/342

(57) ABSTRACT

An apparatus and method for estimating and reporting a Carrier to Interference Noise Ratio (CINR) in a wireless communication system are provided. The wireless communication system receives the CINR reported from the mobile station and transmits data by adaptively setting a coding and modulation level. In a mobile station, a Radio Frequency (RF) processor provided with at least two antennas processes antenna-by-antenna radio signals and converts the radio signals to baseband signals. Switches output or intercept the antenna-by-antenna signals received from the RF processor. An effective CINR measurer measures diversity parameters including a CINR value from the signals output by the switches and outputs the measured diversity parameters. A controller controls an operation for turning on/off the switches on a basis of the diversity parameters received from the effective CINR measurer and generates a report message using the diversity parameters. A transmitter transmits the report message to a base station.

### CROSS-REFERENCE TO RELATED PATENT APPLICATION

This application claims the benefit under 35 U.S.C. § 119(a) of a Korean Patent Application filed in the Korean Intellectual Property Office on Aug. 12, 2005 and assigned Serial No. 2005-74522, the entire disclosure of which is hereby incorporated by reference.

### BACKGROUND OF THE INVENTION

1. Field of the Invention

The present invention generally relates to an apparatus and method for estimating and reporting a Carrier to Interference Noise Ratio (CINR) in a wireless communication system. More particularly, the present invention relates to an apparatus and method for estimating and reporting a CINR in a wireless communication system using multiple antennas.

2. Description of the Related Art

Conventional wireless communication systems communicate between remote terminals without a wired link. The wireless communication systems are divided by a direct wireless communication method for performing direct communication and a wireless communication method using a predetermined relay system. A typical example of the direct wireless communication method is a walkie-talkie. Many other wireless communication systems use a relay system. The wireless communication system has been developed to overcome limitations of a user's position and distance. A typical example of the wireless communication system is a mobile communication system.

With the rapid development of the wireless communication system, various requests are being reflected therein. Among these requests, the greatest request is a high-speed data transmission. Various technical approaches are being developed to transmit data at a high rate. For example, a method increases a bandwidth by transmitting data in a higher band to transmit data at a higher rate. Research is continuously conducted on various methods for transmitting a larger amount of data in the same band. One of the various methods uses multiple antennas.

The multiple antennas are used in many methods. An example of the methods is a smart antenna system. The smart antenna system transmits data by performing beam forming to reduce interference from other terminals at a transmitting side. Another example is a Multi-Input Multi-Output (MIMO) system. The MIMO system transmits data using multiple antennas at transmitting and receiving sides. Another method is a multi-antenna system in which only the receiving side increases the number of antennas to receive data. Thus, the receiving side can increase reception efficiency by increasing the number of antennas.

Maximal Ratio Combining (MRC) is used to increase the reception efficiency by increasing the number of antennas at the receiving side. The MRC maximizes a Carrier to Interference Noise Ratio (CINR) by varying a phase of an antenna signal and assigning a weight to the antenna signal using channel information from each antenna. The MRC can improve reception performance, but increases complexity due to channel information measurement and weight computation in a mobile station (MS).

To increase a transmission rate, another method measures a communication channel state such as a CINR and notifies a transmitter of the measured channel state. There is a modulation method suitable for a channel environment, an adaptive modulation method for selecting a coding rate, or an adaptive code rate method.

The above-described multi-antenna system and an Adaptive Modulation & Coding (AMC) method have been independently studied and widely developed. There are ongoing efforts to improve system performance by applying both Institute of Electrical and Electronics Engineers (IEEE) 802.16d and 802.16e systems.

FIG. 1 is a block diagram illustrating an apparatus for estimating a CINR in a mobile station using a single antenna.

A received signal is input to a channel power calculator 101 and a noise power calculator 103. Then, the channel power calculator 101 computes a power value of a carrier signal from the received signal and then outputs the computed power value. The noise power calculator 103 computes a power value of a noise and interference signal from the received signal and then outputs the computed noise and interference power value. Then, a CINR calculator 105 computes and outputs a ratio between the power values output from the channel power calculator 101 and the noise power calculator 103. A CINR value output from the CINR calculator 105 is input to a CINR estimate generator 107. The CINR estimate generator 107 performs a mapping process to report the computed CINR value to a base station (BS). That is, the CINR estimate generator 107 generates MRC information or reports the CINR value on the basis of information negotiated with the base station when reporting the CINR value to the base station. The generated information is reported to the base station through a CINR transmitter 109. That is, the CINR transmitter 109 can transmit an actual estimated CINR value or a different value mapped thereto.

Through this process, the base station can transmit a downlink signal to the mobile station by setting a code rate and a modulation level suitable for a channel situation.

FIG. 2 is a block diagram illustrating a structure for reporting a CINR in an MRC mobile station using two different antennas. A structure and operation for reporting a CINR in the mobile station using the two antennas will be described with reference to FIG. 2.

The different antennas ANT0 and ANT1 input radio channel signals to Radio Frequency (RF) units 201 and 211. Then, the RF units 201 and 211 perform a low-noise amplification operation and an RF processing operation on the input signals and then output the processed signals. The signals output from the RF units 201 and 211 are input to mixers 203 and 213. The mixers 203 and 213 perform a band down-conversion process by multiplying the RF processed signal by a carrier signal and output a band down-converted signal, respectively. The band down-converted signals are input to band filters and Analog-to-Digital Converters (ADCs) 205 and 215 coupled to the antennas, such that necessary band signals are extracted and are converted from analog signals to digital signals. The band filters and ADCs 205 and 215 output the digital signals. In practice, a group of the RF units 201 and 211, the mixers 203 and 213, and the band filters and ADCs 205 and 215 can be referred to as an RF processor. As described above, the digital signals output from the RF processor are input to switches 207 and 217. The switches 207 and 217 output or intercept the digital signals under control of a controller (not illustrated in FIG. 2). While a signal is received from the base station, the switches 207 and 217 are in a closed state. When no signal is received, the switches 207 and 217 are in an open state. When no data is received, the RF units 201 and 211, the multipliers 203 and 213, and the band filters and ADCs 205 and 215 are controlled such that they do not operate.

In the mobile station using at least two antennas, a combiner 209 combines and uses the received signals. Thus, the combiner 209 combines the signals output from the switches 207 and 217 and then outputs the combined signals. Further, the signals output from the switches 207 and 217 are input to a CINR measurer 221. The CINR measurer 221 measures CINRs of the signals received from the antennas ANT0 and ANT1, and outputs the measured CINRs to a CINR transmitter 223. The CINR transmitter 223 transmits the measured CINRs to the base station.

When multiple antennas are conventionally used, a signal transmitted from a transmitter has different antenna paths. Thus, the antenna-by-antenna received signals are different. Further, characteristics of a channel from the transmitter to each antenna affect the reception performance of a receiver. Because signals received by the antennas have different characteristics, the signals received by the first and second antennas ANT0 and ANT1 in the structure of FIG. 2 are defined as shown in Equation (1).
y₀=H₀s+w₀
y₁=H₁s+w₁ Equation (1)

In Equation (1), s is a transmitted signal, y₀ is the signal received by the first antenna, y₁ is the signal received by the second antenna, and w₀ and w₁ are interference and noise components. w₀ and w₁ have the variance of N₀, respectively. H₀ and H₁ are channel response characteristics between the base station and the antennas.

When the channel response characteristics are defined by H₀ and H₁ as shown in Equation (1), a combination value z obtained by the combiner 209 of FIG. 2 can be defined as shown in Equation (2).
z=H*₀y₀+H*₁y₁
=(|H₀|²+|H₁|²)s+H*₀w₀H*₁w₁ Equation (2)

In Equation (2), H*₀ and H*₁ are conjugates of the channel response characteristics H₀ and H₁ between the base station and the antennas.

A CINR measured at a particular time on the basis of the above-described values can be defined by Equation (3).

$$CINR = \frac{E [ {\vert {H}_{0} \vert}^{2} + {\vert {H}_{1} \vert}^{2} ]}{{N}_{0}} \qquad Equation ( 3 )$$

If H₀ and H₁ have the same power, Equation (3) can be rewritten as Equation (4).

$$CINR = \frac{2 E [ {\vert {H}_{0} \vert}^{2} ]}{{N}_{0}} \qquad Equation ( 4 )$$

According to Equation (4), a CINR gain of a receiver using two antennas is 3 dB greater than that of a receiver using a single antenna. Among signal components of Equation (2), a probability distribution of (H₀|²+|H₁|²) additionally improves reception performance. This is referred to as a diversity gain distinguished from the CINR gain. Parameters relating to the diversity gain are the number of antennas, and interchannel interference, among others. Parameters relating to the diversity gain are referred to as diversity parameters.

FIG. 3 is a graph illustrating simulation results of a reception performance comparison between a two-antenna receiver and a single-antenna receiver. FIG. 4 is a graph illustrating simulation results of reception performance based on an effective CINR including a CINR gain at the time of using two antennas that is 3 dB greater than that at the time of using a single antenna.

According to FIG. 3, the two-antenna receiver has more improved CINR characteristics in comparison with the single-antenna receiver. With reference to FIG. 4, a CINR gain greater than 3 dB is obtained when the two antennas are used.

Because performance improvement is obtained when multiple antennas are used, a receiving side needs to report a CINR value in a different method according to whether the multiple antennas are used. That is, data can be efficiently transmitted only when the receiving side correctly notifies a transmitting side of a channel state according to the case in which both the switches 207 and 217 as illustrated in FIG. 2 are in the closed state.

Alternatively, when the number of antennas increases as illustrated in FIG. 2, an RF unit, a multiplier, and a band filter and ADC should be different between antennas. Power consumed by the devices of the above-described structure is significant. Considering that wireless terminals are mostly portable, the usage time and waiting time of the mobile station are significantly reduced. Thus, the wireless communication system needs to consider not only a high-speed data transmission or a transmission of a larger amount of data but also the usage time or waiting time of the mobile station.

Accordingly, there is a need for an improved apparatus and method capable of considering both high-speed data transmission or a transmission of a larger amount of data and the usage time or waiting time of the mobile station.

### SUMMARY OF THE INVENTION

An object of an exemplary embodiment of the present invention is to provide an apparatus and method for estimating and reporting a signal to interference noise ratio in a wireless communication system using multiple antennas.

According to another object of an exemplary embodiment of the present invention an apparatus and method are provided to transmit data with greater efficiency. An effective Carrier to Interference Noise Ratio (CINR) is estimated and its parameter value is reported in a wireless communication system using multiple antennas.

It is yet another object of an exemplary embodiment of the present invention to provide an apparatus and method that can increase the usage time of a mobile station and can more correctly estimate and report a CINR in a wireless communication system using multiple antennas.

In accordance with an aspect of an exemplary embodiment of the present invention, there is provided an apparatus for estimating and reporting a Carrier to Interference Noise Ratio (CINR) in a mobile station of a wireless communication system. The wireless communication system receives the CINR reported from the mobile station and transmits data by adaptively setting a coding and modulation level. The apparatus comprises a Radio Frequency (RF) processor, switches, an effective CINR measurer, a controller and a transmitter. The RF processor is provided with at least two antennas to process antenna-by-antenna radio signals and to convert the radio signals to baseband signals. The switches output or intercept the antenna-by-antenna signals received from the RF processor. The effective CINR measurer measures diversity parameters comprising a CINR value from the signals output by the switches and outputs the measured diversity parameter. The controller controls an operation for turning the switches on/off based on the diversity parameters received from the effective CINR measurer and generates a report message using the diversity parameters. The transmitter transmits the report message to a base station.

In accordance with another aspect of an exemplary embodiment of the present invention, there is provided a method for estimating and reporting a Carrier to Interference Noise Ratio (CINR) in a mobile station of a wireless communication system. The wireless communication system receives the CINR reported from the mobile station and transmits data by adaptively setting a coding and modulation level. An operation for receiving signals through at least two antennas is controlled if a CINR measured through a single antenna is less than a preset first threshold value. Diversity parameters comprising an effective CINR are generated and reported when the signals are received through the at least two antennas.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating a conventional apparatus for estimating a Carrier to Interference Noise Ratio (CINR) in a mobile station using a single antenna;

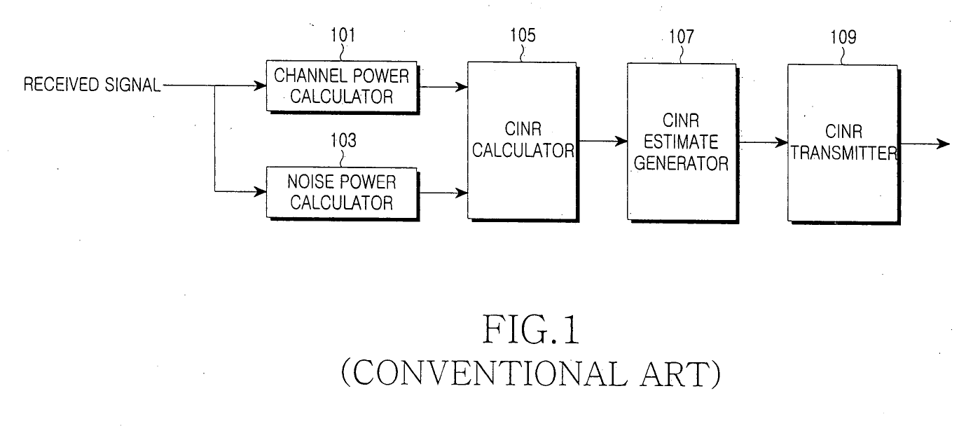

FIG. 2 is a block diagram illustrating a traditional structure for reporting a CINR in a Maximal Ratio Combining (MRC) mobile station using two different antennas;

FIG. 3 is a graph illustrating typical simulation results of a reception performance comparison between a two-antenna receiver and a single-antenna receiver;

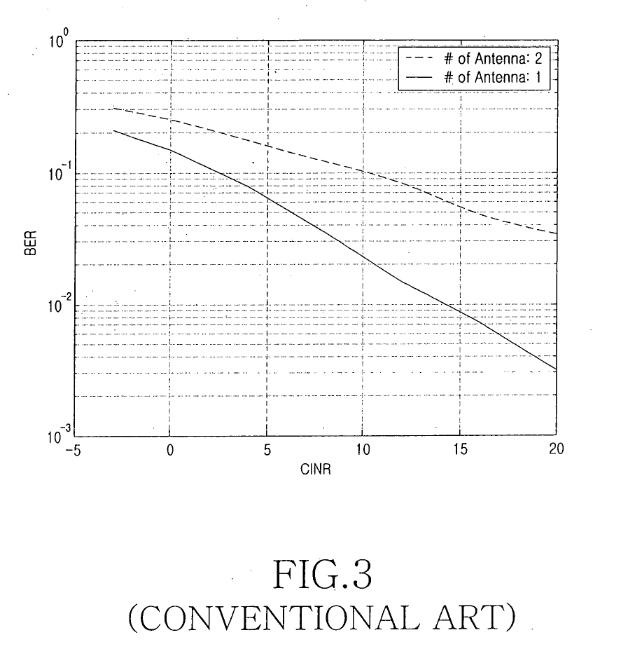

FIG. 4 is a graph illustrating typical simulation results of reception performance based on an effective CINR including a CINR gain at the time of using two antennas that is 3 dB greater than CINR when a single antenna is used;

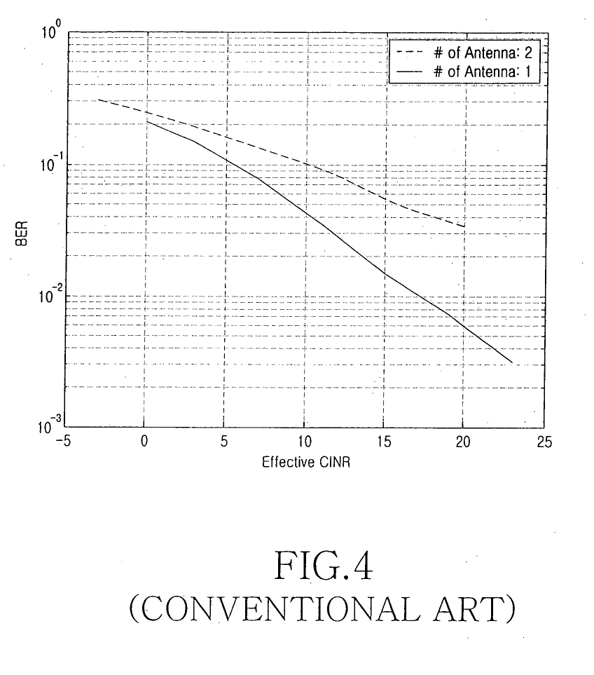

FIG. 5 is a block diagram illustrating a structure for estimating and reporting an effective CINR and a diversity parameter in a mobile station in accordance with an exemplary embodiment of the present invention;

FIG. 6 is a timing diagram illustrating a difference between application times of an effective CINR report message when the number of used antennas is changed according to an exemplary embodiment of the present invention;

FIG. 7 is a timing diagram illustrating synchronization between application times of an effective CINR report message when the number of used antennas is changed according to an exemplary embodiment of the present invention; and

FIG. 8 is a flowchart illustrating a control flow when multiple antennas are turned on/off in accordance with an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the spirit and scope of the invention. Also, descriptions of well-known functions and constructions are omitted for clarity and conciseness.

When a demodulator structure of the multi-antenna system is compared with that of a single-antenna system, a significant reception performance difference is shown. Thus, a Carrier to Interference Noise Ratio (CINR) should be separately defined with respect to multiple antennas and should be reported to a base station (BS). When a demodulation stage of the multi-antenna system has a substantially increased CINR compared to that of the single-antenna system. For example, when two antennas are used and are sufficiently spaced from each other, a CINR gain of more than 3 dB can be obtained during Maximal Ratio Combining (MRC). In the following description, an exemplary embodiment of the present invention proposes an improved apparatus for estimating a CINR according to the number of antennas by considering a CINR gain. In this exemplary embodiment of the present invention, the multi-antenna system estimates and reports a CINR by defining the CINR to be reported to the base station as an effective CINR.

Second, the exemplary embodiment of present invention proposes a method for estimating an effective CINR and diversity parameter, for example, the number of antennas, and a correlation coefficient between channels, among others. According to an exemplary implementation, there is also a method for feeding back the effective CINR and the diversity parameters to a transmitter, when multi-antenna technology and Adaptive Modulation & Coding (AMC) are simultaneously used. In an exemplary embodiment of the present invention, an MRC stage of a multi-antenna mobile station (MS) sets the effective CINR and sends a value of the effective CINR to the base station. Generally, a gain of a receiver with multiple antennas is increased by an increase in an average CINR value and a change in a probability distribution of a CINR. Therefore, the number of antennas corresponding to an item relating to the diversity gain as well as the CINR is reported to the base station, such that the base station effectively sets an AMC level and assigns the set AMC level to each user.

Third, the multi-antenna system adjusts the number of antennas to be used for diversity according to hardware complexity. When the number of antennas is adjusted, the number of antennas to be used is changed and therefore an effective CINR is changed. Because the transmitter sets an AMC level using a previously reported CINR value and transmits data, reception performance may be degraded after a switching time for adjusting the number of antennas. For example, in the case of Code Division Multiple Access (CDMA) 2000x, the AMC level is defined in a unit of 1.5 dB. To prevent the performance degradation, an apparatus of an exemplary embodiment of the present invention reports a CINR by considering variation in antenna performance before a CINR switching time.

For this operation, an exemplary embodiment of the present invention proposes a method for estimating an effective CINR of Equation (3) as described with reference to the prior art and for reporting the estimated effective CINR. When only an effective CINR is reported without diversity parameter information, the base station considers the associated receiver as a single-antenna receiver and sets an AMC level according to a performance criterion mapped to the single-antenna receiver.

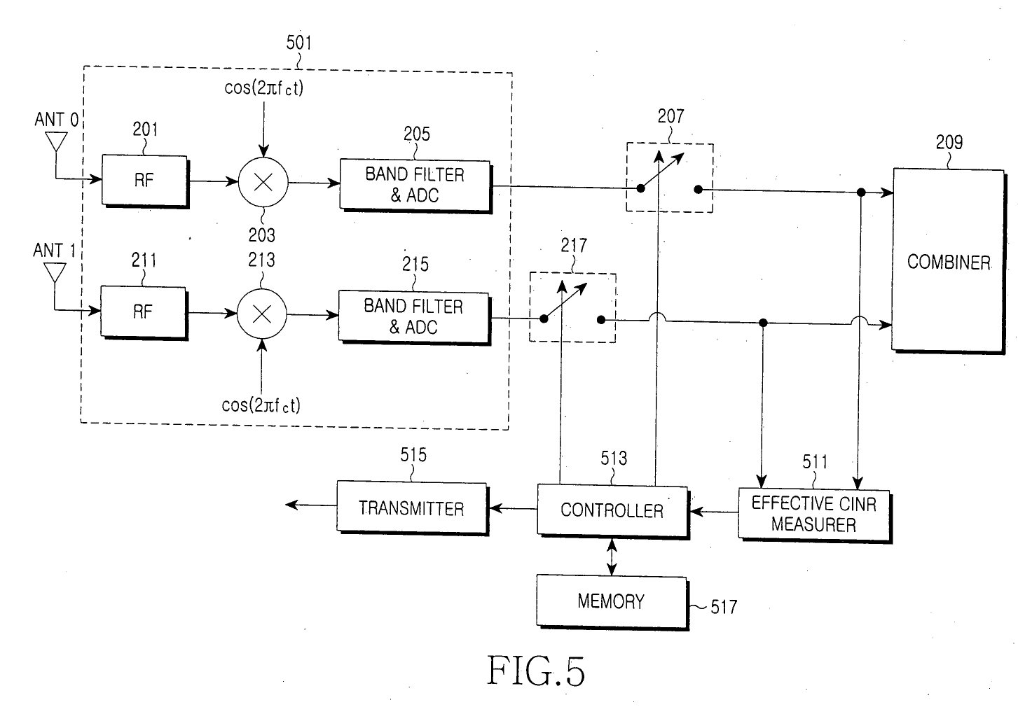

FIG. 5 is a block diagram illustrating a structure for estimating and reporting an effective CINR and a diversity parameter in a mobile station in accordance with an exemplary embodiment of the present invention. The structure and operation for estimating and reporting an effective CINR and a diversity parameter in the mobile station in accordance with an exemplary embodiment of the present invention will be described in detail with reference to FIG. 5.

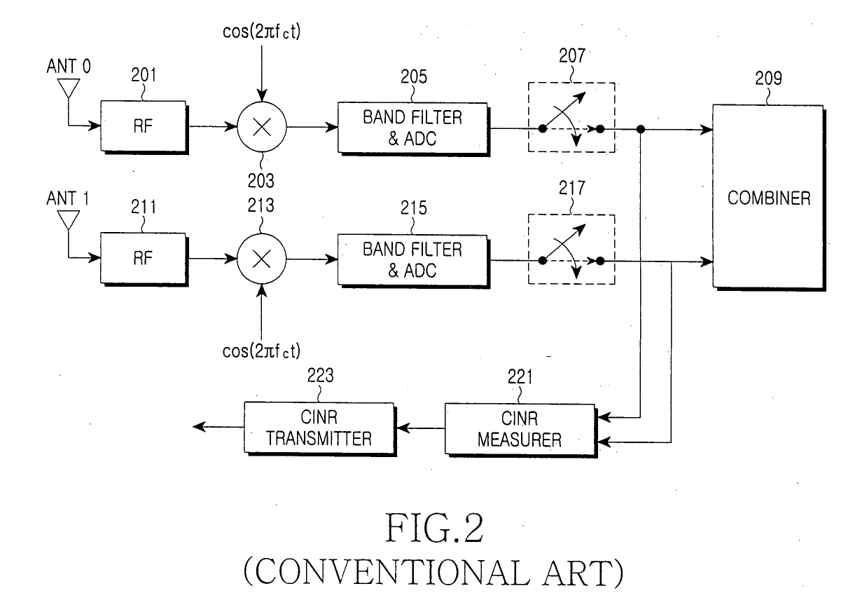

The structure of FIG. 5 from antennas ANT0 and ANT1 to a combiner 209 is similar to that of FIG. 2 as described with reference to the conventional art. A part corresponding to a Radio Frequency (RF) processor as described with reference to the conventional art is denoted by reference numeral 501 in FIG. 5. The structure of FIG. 5 includes a controller 513 for controlling switches 207 and 217.

An exemplary embodiment of the present invention uses a method for reporting a measured CINR and diversity parameters such as the number of used antennas and so on to the base station. That is, an exemplary embodiment of the present invention variably uses the number of antennas in case of need.

When a cellular system is considered, reception performance is degraded due to an increase in interference at a boundary between cells thereof. However, due to a high degree of performance degradation in a recent Wireless Broadband (WiBro) system in which a frequency reuse factor is 1 even when low-level AMC is used, communication may be impossible. However, an exemplary embodiment of the present invention can ensure reception sensitivity necessary for communication by enabling a diversity operation, thereby continuously performing communication. According to an exemplary implementation, only one antenna is normally used. When the performance degradation is large as described above, the diversity can be acquired using at least two antennas. For example, when the reception sensitivity is good, the general operation is performed only using one antenna. However, when the reception sensitivity is bad at a cell boundary or due to an obstacle, the diversity can be acquired by operating spare antennas. In practice, an exemplary embodiment of the present invention can use at least two antennas.

In an exemplary embodiment of the present invention, an effective CINR measurer 511 measures the number of antennas currently being used for the RF processor and a CINR based on the number of used antennas and reports the number of used antennas and the CINR to the controller 513. That is, diversity parameters are provided to the controller 513. The controller 513 generates an effective CINR report message including the provided diversity parameters and sends the generated message to the base station through a transmitter 515. In an exemplary embodiment of the present invention, the controller 513 controls an operation for employing one antenna or at least two antennas. That is, to first employ one antenna, the controller 513 controls one of the switches 207 and 217 to be maintained in an ON state and controls the other switch to be maintained in an OFF state. Then, the effective CINR measurer 511 provides the controller 513 with a CINR of a signal received from the antenna in the ON state and a diversity parameter indicating the use of one antenna. If a CINR measured from one antenna used for communication is less than a preset threshold value, the controller 513 turns on the other switch which is in the OFF state in which a signal has been received from the other antenna but has not been processed, thereby acquiring a diversity gain. According to an exemplary implementation, the preset threshold value can be set by experimentation or can use a CINR required in a particular system. A required CINR value may differ according to a system.

If a CINR value is equal to or greater than the preset threshold value while data is received through at least two antennas, the: controller 513 turns off one of the switches. Then, a signal can be received through at least one remaining antenna. At this time, the controller 513 provides the base station with an effective CINR and a diversity parameter mapped to the at least one remaining antenna.

In the above-described operation, transmission time points of effective CINR report messages are different between the mobile station and the base station. Thus, a method for compensating for a difference is needed.

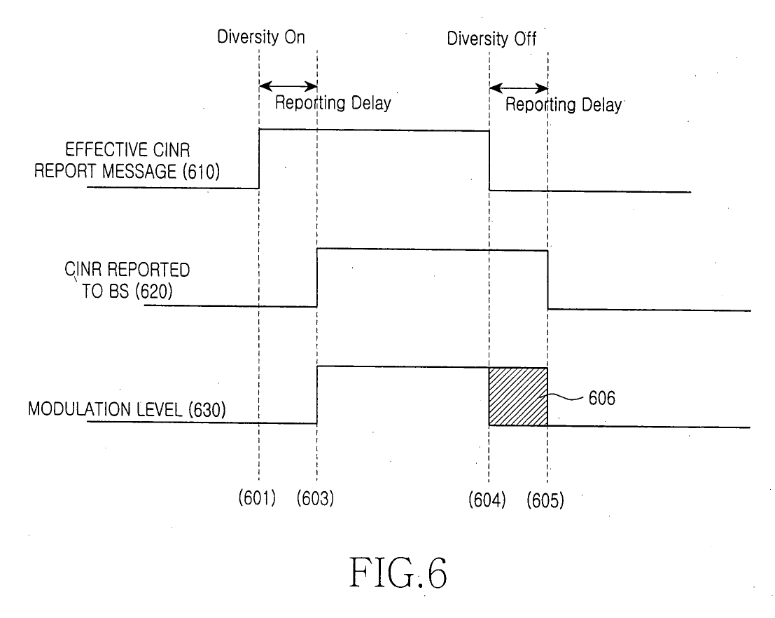

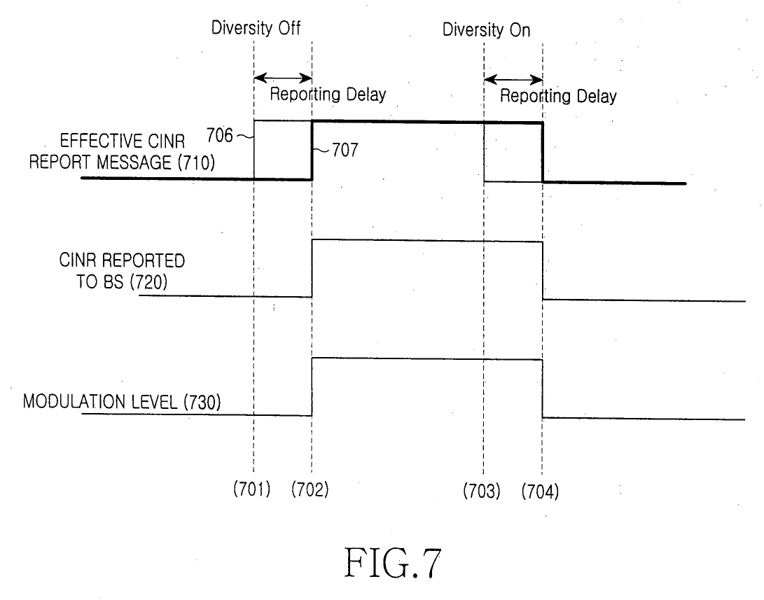

FIG. 6 is a timing diagram illustrating a difference between application times of an effective CINR report message when the number of used antennas is changed in an exemplary embodiment of the present invention. FIG. 7 is a timing diagram illustrating synchronization between application times of an effective CINR report message when the number of used antennas is changed in an exemplary embodiment of the present invention.

First, FIG. 6 illustrates an effective CINR report message value 610, a CINR 620 reported to the base station, and a modulation level 630. The effective CINR report message value 610 is a value of an effective CINR measured by the mobile station. The CINR 620 reported to the base station is an effective CINR message containing a diversity parameter. Further, the modulation level 630 is an applied modulation level when data is transmitted from the base station.

As illustrated in FIG. 6, the mobile station measures an effective CINR and reports the measured effective CINR. When the mobile station for performing communication through one of multiple antennas provided therein is on the move or when a peripheral wireless situation is bad, such as, an effective CINR value measured only through one antenna of the mobile station is less than a preset threshold value, the mobile station turns on a switch of a signal line provided from the other antenna to provide an output from the other antenna. A point of time when the controller 513 of the mobile station turns on the switch is denoted by reference numeral 601. When at least two antennas are used at the time point 601, an effective CINR has an improved performance value. Thus, the controller 513 of the mobile station includes improved performance information in a diversity parameter and reports the diversity parameter to the base station through the transmitter 515. A reporting delay time occurs in relation to a time of propagating a radio signal and a time of processing the radio signal received from the base station. That is, the reporting delay time occurs between the time point 601 and a time point 603. According to delayed reported information, the base station applies the modulation level 630 with high modulation degree at the time point 603.

According to an exemplary implantation, a CINR value measured by the mobile station is equal to or greater than a preset threshold value. This corresponds to the case in which the mobile station moves from a cell boundary to a cell center or moves away from an obstacle while performing communication using at least two antennas. In this case, the mobile station turns off a switch connected to an output line from the remaining antenna except a line of one antenna side such that only one antenna can be used. Then, an effective CINR measured again is lower than that of the case in which multiple antennas are used. Thus, the controller 513 of the mobile station generates an effective CINR message containing a diversity parameter and transmits the effective CINR message to the base station through the transmitter 515. A delay time also occurs between a time of generating the effective CINR report message in the controller 513 of the mobile station and propagating a radio wave and a time of processing and applying the effective CINR report message in the base station.

This delay time is from a time point 604 to a time point 605. Thus, the base station transmits data in a high modulation level even when the mobile station has a low effective CINR because multiple antennas are not already used at the time point 604. This phenomenon is maintained up to the time point 605. When this phenomenon occurs, the mobile station may not demodulate a signal received in the high modulation level. A probability that an operation for decoding a signal modulated in the high level will fail becomes very high. As a result, a probability that transmission error will occur becomes high when data is transmitted from the base station during a time interval as indicated by a shaded portion 606. When this transmission error occurs, the base station should retransmit data transmitted in the time interval as indicated by the shaded portion 606. When the data is retransmitted, transmission efficiency is degraded in the overall system and therefore power can be unnecessarily consumed in the wireless terminal.

In an exemplary embodiment of the present invention, a memory 517 can further store information for compensating for the above-described problem. According to an exemplary implementation, expected information may be included in the memory 517 and expected information may be unnecessary.

First, information to be stored will be described when expected information is unnecessary in the memory 517. In an exemplary embodiment of the present invention, the memory 517 should store time information of a required reporting delay in advance. The memory 517 should store time information of a reporting delay when a change to multi-antenna mode is made and should store time information of a reporting delay when a change to single-antenna mode is made. The two information elements may be different from or equal to each other.

Next, the case in which expected information is required in the memory 517 will be described. The memory 517 stores an effective CINR measured when a single antenna is used, expected information of a CINR improved when multiple antennas are used, and expected information of a CINR that is lower than an effective CINR measured in the multi-antenna mode when the change to the single-antenna mode is made.

According to an exemplary implementation, FIG. 7 illustrates a case in which no expected value is stored in the memory 517. When no expected value is stored in the memory 517, the effective CINR measurer 511 should provide the controller 513 with CINR values of signals received from individual antennas and an effective CINR report message value.

When a CINR value is less than a preset threshold value while a single antenna is used, the controller 513 makes the change to the multi-antenna mode. When the change to the multi-antenna mode is made, the controller 513 turns on a switch connected to an unused antenna at a time point 701. When the switch is turned on, the effective CINR measurer 511 provides antenna-by-antenna CINR values, an effective CINR value, and a diversity parameter value. Then, the controller 513 generates an effective CINR report message containing the received effective CINR value and the diversity parameter, and transfers the effective CINR report message to the base station through the transmitter 515. As described with reference to FIG. 6, the base station requires a predetermined delay time to receive and apply the effective CINR report message. A low modulation level is applied before a time point 702 when the effective CINR value is applied and the modulation level 730 is changed to a high modulation level as illustrated in FIG. 7. Thus, the memory 517 should store information of a minimum transmission time. Because the information of the minimum transmission time is stored, the mobile station waits for the minimum transmission time without immediately making a change to the multi-antenna mode, thereby reducing its power consumption.

If an effective CINR value measured using the multiple antennas is greater than another preset threshold value in the multi-antenna mode, the controller 513 of the mobile station decides to return to the single-antenna mode. At this time, the comparison with the threshold can use a CINR value of a particular antenna without use of an effective CINR value, because the memory 517 may not be used to store a ratio value between an effective CINR value in the multiple antennas and a CINR value in the single antenna. Further, individual antenna values can be used because the effective CINR measurer 511 reports an effective CINR value and antenna-by-antenna CINR values to the controller 513.

When the transition to the single-antenna mode is set, the controller 513 generates a CINR value to be used in the single-antenna mode and reports the generated CINR value to the base station. However, the controller 513 turns off a switch connected to an antenna to be unused after a delay time corresponding to the information stored in the memory 517 without immediately turning off the switch connected to the antenna to be unused. Thus, the switch is turned off at a time point 704 rather than a time point 703 of FIG. 7. That is, the memory 517 should store information of a maximum time corresponding to a period of time until a CINR measured by the mobile station is reported and applied to the base station. Once the maximum time has elapsed, the switch is turned off so that data of a high modulation level can be smoothly received even though a low modulation level is later applied.

According to an exemplary implementation, a switching time can be adjusted by using only the minimum and maximum time information stored in the memory 517. A time interval from the time point 701 to the time point 702 of FIG. 7 may be different from a time interval from the time point 703 to the time point 704.

Next, an example in which expected CINR information is stored in the memory 517 and is used in the controller 513 will be described with reference to FIG. 7. In the following description, it is assumed that a transmission from the base station to the mobile station does not have a delay time.

If the above-described condition is satisfied while a signal received from the base station is processed using a single antenna, the controller 513 of the mobile station decides to use the multiple antennas. Thus, the controller 513 reads an expected CINR value increased in the multi-antenna mode stored in the memory 517 on the basis of an effective CINR value received from the effective CINR measurer 511. An effective CINR report message is generated as if an effective CINR has been measured at the time point 701 before the transition to the multi-antenna mode as indicated by a curve 706. At this time, a diversity parameter is contained in the effective CINR report message. That is, the mobile station reports, to the base station, an effective CINR report message containing an expected effective CINR, a diversity parameter, and the delay time previously stored in the memory 517 under the assumption that at least two antennas have been applied.

As described above, the base station receives the effective CINR report message at a time point after a predetermined delay time. Thus, a CINR 720 reported to the base station is an expected value rather than a value actually measured by the mobile station. Using the reported expected CINR value, the base station changes the modulation level 730 from a low level to a high level at the time point 702. Then, the base station transmits data to the mobile station in the high modulation level. Because the time point 702 corresponds to a reporting delay time previously stored in the mobile station, the diversity gain increases when the multiple antennas are actually used at the time point 702 as indicated by a curve 707. At this time, the mobile station at the receiving side can use the multiple antennas from the time point 701 when the effective CINR report message 710 is transmitted or from the time point 702 after the previously stored time has elapsed. When the diversity effect is no longer needed, such as, the mobile station closely moves to the base station or exits an obstacle area, the mobile station returns to the single-antenna mode without use of the multiple antennas. At a predetermined time point before the mobile station returns to the single-antenna mode, the controller 513 generates an effective CINR report message containing an expected effective CINR and diversity parameter under the assumption that the mobile station has returned to the single-antenna mode using the information stored in the memory 517. The controller 513 controls the transmitter 515 to transmit the generated effective CINR report message to the base station. This time point is indicated by reference numeral 703 in FIG. 7.

At the time point 703, the mobile station transmits the expected effective CINR report message to the base station. After the delay time, the base station receives a CINR value. That is, the base station transmits data in a low modulation level from the time point 704. Further, the controller 513 of the mobile station stops the use of the multiple antennas using the maximum delay time information stored in the memory 517. According to an exemplary implementation, the controller 513 turns off a multi-antenna switch after a preset time and uses only one antenna. At the time of reporting, a reporting process is performed as indicated by the solid line 706. The multi-antenna switch is actually turned on/off as indicated by the bold solid line 707.

The case in which a delay time of a transmission from the base station to the mobile station is absent has been described above. Alternatively, assuming that a delay time of a transmission from the base station to the mobile station is present, a turn off/on time of a switch can be set by the delay time of the transmission from the base station to the mobile station

The information stored in the memory has been described under the following assumptions.

First, when a fixed number of antennas are used, a time-variant CINR is low and a difference between a current CINR and a CINR estimate after a reporting delay is small.

Second, when a CINR is reported in a period, a reporting delay corresponds to the period. When a maximum CINR reporting time interval is present, its value is considered as the reporting delay in the mobile station.

Before a transition is taken from diversity OFF state to diversity ON state in actual implementation of the above-described system, the number of used antennas is one and a CINR estimate is computed using one antenna. Further, when a transition is taken from the diversity OFF state to the diversity ON state, a transition time point, such as, a time point for turning on an antenna, can be set by estimating individual CINRs of used antennas and an effective CINR is estimated. In other words, because CINRs of two antennas and an effective CINR using the two antennas can be simultaneously estimated in the diversity ON state, such as, when the two antennas are used in the diversity ON state, a diversity OFF time point is set on the basis of three CINR estimates. From this diversity OFF time point, a CINR of an antenna to be used before a reporting delay is reported.

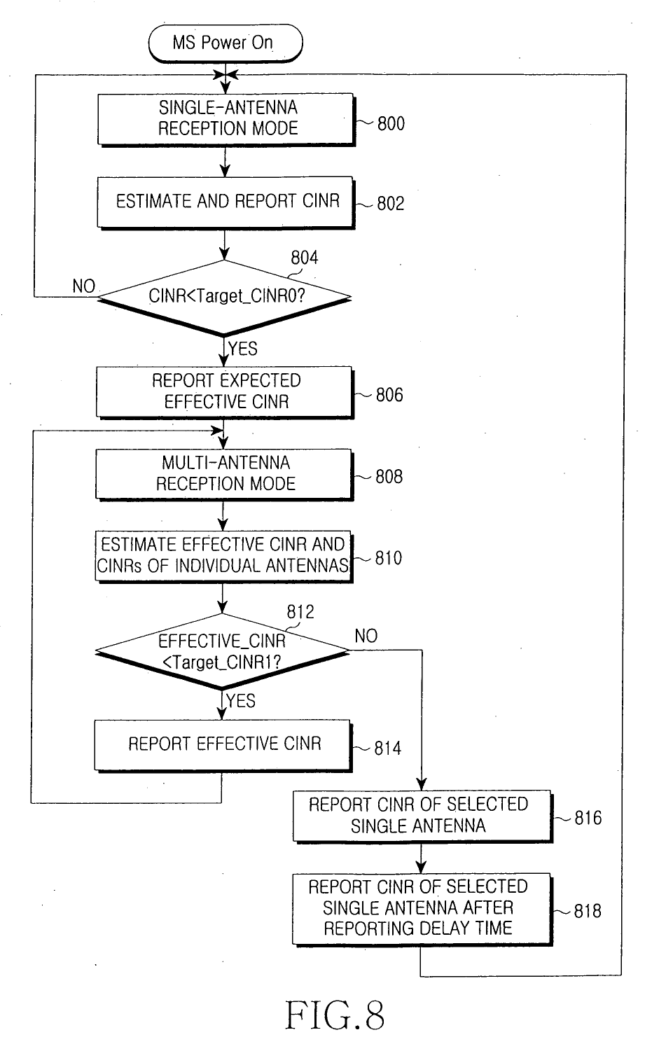

FIG. 8 is a flowchart illustrating a control flow at the time of turning on/off multiple antennas in accordance with an exemplary embodiment of the present invention. A process for turning on/off the multiple antennas in accordance with an exemplary embodiment of the present invention will be described in detail with reference to FIG. 8.

When a power supply of the mobile station is turned on, a single-antenna reception mode operates in step 800. In this case, the mobile station transmits a signal to and receives a signal from the base station through one of the antennas ANT0 and ANT1 of FIG. 5. While this state is maintained, the mobile station measures a CINR through the RF processor 501 in step 802. The mobile station periodically or continuously reports a measured CINR value in step 802. That is, the controller 513 receives a CINR value of the single antenna from the effective CINR measurer 511, generates a CINR report message, and reports the generated message to the base station through the transmitter 515.

While this operation is performed, the controller 513 determines whether a CINR lower than a first threshold value (Target_CINR0) stored in the memory 517 is received from the effective CINR measurer 511 in step 804. If a CINR lower than the first threshold value is measured as a determination result of step 804, the controller 513 proceeds to step 806. Otherwise, the controller 513 proceeds to step 800 to continuously maintain the single-antenna reception mode.

When proceeding to step 806 since the measured CINR has been determined to be less than the first threshold value in step 804, the controller 513 reads an expected effective CINR value stored in the memory 517 as described with reference to FIG. 7 on the basis of the CINR value currently measured through the single antenna. Then, the controller 513 controls the transmitter 515 to report the effective CINR value read in step 806. After reporting, the controller 513 proceeds to step 808 to perform the multi-antenna mode when a transmission delay time stored in the memory 517 has elapsed. That is, when the two antennas are used as illustrated in FIG. 5, the controller 513 turns on a turn off switch of the switches when a preset transmission delay time has elapsed, such that data is received through the two different antennas.

Alternatively, another method can be used which immediately turns on a switch without waiting for a preset time after reporting a message. In this case, the memory 517 does not need to store an expected value. That is, the controller 513 immediately transmits a diversity parameter and a CINR measured in the effective CINR measurer 511.

However, there is a required waiting time until the modulation level increases and when the switch is immediately turned on. This waiting time is required according to a transmission delay time and a scheduling time of the base station. However, when the switch is turned off, the memory 517 must store an expected value because the switch should not be turned off immediately.

The controller 513 proceeds to step 808 to perform a multi-antenna reception mode. Once a preset delay time has elapsed while the multi-antenna reception mode is performed, the controller 513 proceeds to step 810 to generate an effective CINR report message containing an effective CINR and a diversity parameter in relation to signals received through the multiple antennas and transmit the generated message to the base station. While reporting an effective CINR value, the controller 513 proceeds to step 812 to determine whether a measured effective CINR value is equal to or greater than a preset second threshold value (Target_CINR1). If the measured effective CINR value is less than the preset second threshold value as a determination result of step 812, the controller 513 proceeds to step 814. However, if the measured effective CINR value is equal to or greater than the preset second threshold value, the controller 513 proceeds to step 816.

When proceeding to step 814, the controller 513 periodically or continuously reports an effective CINR received from the effective CINR measurer 511. Alternatively, when proceeding to step 816, the controller 513 reports a CINR value of an antenna to be used among antenna-by-antenna CINRs received from the effective CINR measurer 511 to the base station through the transmitter 515. When computed information is stored in the memory 517, the controller 513 reads an expected CINR value from the memory 517 in the single-antenna mode on the basis of the current effective CINR value and reports the read expected CINR value to the base station through the transmitter 515.

After reporting the CINR value to be used in the single-antenna mode in step 816, the controller 513 proceeds to step 818 to release the multi-antenna mode after a predetermined time stored in the memory 517 and receive data through a selected single antenna. That is, the controller 513 turns off the remaining antennas except the selected antenna in step 818. The controller 513 generates a CINR report message containing a CINR value measured through the selected antenna and controls the transmitter 515 to transmit the CINR report message.

An exemplary embodiment of the present invention can increase system throughput, prevent unnecessary power consumption in a mobile station, and increase the usage time of the mobile station, when multiple antennas are used at a necessary time point.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for estimating and reporting a Carrier to Interference Noise Ratio (CINR) in a mobile station of a wireless communication system, the wireless communication system receiving the CINR reported from the mobile station and transmitting data by adaptively setting a coding and modulation level, the apparatus comprising:
a Radio Frequency (RF) processor, comprising at least two antennas, for processing radio signals and converting the radio signals to baseband signals;
switches for connecting or disconnecting baseband signal paths;
an effective CINR measurer for measuring diversity parameters comprising a CINR value from the baseband signals and for outputting the measured diversity parameters;
a controller for controlling the switches connecting or disconnecting baseband signal paths on a basis of the diversity parameters received from the effective CINR measurer and for generating a report message using the diversity parameters; and
a transmitter for transmitting the report message to a base station.

2. The apparatus of claim 1, wherein the diversity parameters comprise the number of used antennas and at least one value of antenna-by-antenna CINR values and an effective CINR value when the at least two antennas are used.

3. The apparatus of claim 2, wherein the controller controls the switch for connecting the baseband path if a CINR value measured through a single antenna is less than a first threshold value when the single antenna is used and for receiving data through the at least two antennas, and controls the switch for disconnecting the baseband path if an effective CINR value is greater than a second threshold value when the at least two antennas are used and receiving data through a single antenna.

4. The apparatus of claim 3, wherein the controller controls the switch for disconnecting the baseband path after maintaining multi-antenna reception mode during a time period when a change to single-antenna mode is made while the at least two antennas are used.

5. The apparatus of claim 4, wherein the time period comprises a maximum delay time required for transmitting data to the mobile station after the base station of the wireless communication system sets the coding and modulation level.

6. The apparatus of claim 3, wherein the controller controls the switch for connecting the baseband path after maintaining a single-antenna mode during a time period when a change to multi-antenna reception mode is made while the single antenna is used.

7. The apparatus of claim 6, wherein the time period comprises a minimum delay time required for transmitting data to the mobile station after the base station of the wireless communication system sets the coding and modulation level.

8. The apparatus of claim 2, further comprising a memory for storing time information of a reporting delay when a change to a multi-antenna mode is made and storing time information of a reporting delay when a change to a single-antenna mode is made.

9. A method for estimating and reporting a Carrier to Interference Noise Ratio (CINR) in a mobile station of a wireless communication system, the wireless communication system receiving the CINR reported from the mobile station and transmitting data by adaptively setting a coding and modulation level, the method comprising:
controlling an operation for receiving signals through at least two antennas if a CINR measured through a single antenna is less than a first threshold value; and
generating and reporting diversity parameters comprising an effective CINR when the signals are received through the at least two antennas.

10. The method of claim 9, further comprising:
generating and reporting in advance diversity parameters comprising a CINR value of one antenna selected from the at least two antennas if an effective CINR value is greater than a preset threshold value when the signals are received through the at least two antennas; and
receiving data through the selected antenna when a time period has elapsed after reporting.

11. The method of claim 10, wherein the time period comprises a maximum delay time required for transmitting data to the mobile station after a base station of the wireless communication system sets the coding and modulation level.

12. The method of claim 9, wherein the diversity parameters comprise the number of used antennas and at least one value of antenna-by-antenna CINR values and an effective CINR value when the at least two antennas are used.

13. The method of claim 9, further comprising:
reporting an expected effective CINR value to a base station before operating switches for the at least two antennas if the CINR measured through the single antenna is less than the first threshold value; and
controlling an operation for receiving the signals through the at least two antennas when a preset time has elapsed.

14. The method of claim 13, wherein the expected effective CINR value comprises a previously stored value mapped to CINR values measured through the at least two antennas.

15. The method of claim 13, wherein the time period comprises a minimum delay time required for transmitting data to the mobile station after the base station of the wireless communication system adaptively sets the coding and modulation level.

16. A method for estimating and reporting a Carrier to Interference Noise Ratio (CINR) in a mobile station of a wireless communication system, the wireless communication system receiving the CINR reported from the mobile station and transmitting data by adaptively setting a coding and modulation level, the method comprising:
reporting an expected effective CINR value to a base station before operating switches for multiple antennas if a CINR measured through a single antenna is less than a threshold value; and
controlling an operation for receiving signals through the multiple antennas when a time period has elapsed.

17. The method of claim 16, wherein the expected effective CINR value comprises a previously stored value mapped to CINR values measured through the multiple antennas.

18. A method for estimating and reporting a Carrier to Interference Noise Ratio (CINR) in a mobile station of a wireless communication system, the method comprising:
operating in a single-antenna reception mode when a power supply of a mobile station is turned on;
receiving a CINR value of the single antenna from an effective measurer;
determining whether a CINR lower than a first threshold value stored in a memory is received from an effective CINR measurer;
reporting an effective CINR value;
performing a multi-antenna mode if the effective CINR lower than the first threshold value after a transmission delay time stored in the memory has elapsed;
generating an effective CINR report message containing an effective CINR and a diversity parameter in relation to signals received through multiple antennas and transmitting the generated message to a base station;
determining whether a measured effective CINR value is equal to or greater than a second threshold value;
reporting the effective CINR if the measured effective CINR value is less than the second threshold value as a determination result; and
reporting the CINR of a selected single antenna if the measured effective CINR value is equal to or greater than the second threshold value and releasing the multi-antenna mode after a reference time stored in the memory and receiving data through a selected single antenna.
